(19) United States
(12) Patent Application Publication
(10) Pub. No.: US 2011/0106883 A1
(43) Pub. Date: May 5, 2011

(54) REMOTE COMPUTING SERVICES

(76) Inventors: Ajay Gupta, Bangalore (IN); Phillip A. Leech, Houston, TX (US); Vanish Talwar, Palo Alto, CA (US)

(21) Appl. No.: 12/999,260

(22) PCT Filed: Jul. 1, 2008
(86) PCT No.: PCT/US2008/068927

§ 371 Date: Jan. 14, 2011

(51) Int. Cl. G06F 15/16

(52) U.S. Cl. 709/203

(57) ABSTRACT

A computing architecture is operable to provide remote computing services. The computing architecture includes client computer systems provided to regions to receive remote computing services, server computer systems providing remote computer services for the client computer systems, first network connections providing connectivity between client computer systems and server computer systems, and second network connections server computer systems amongst each other. The server computer systems are configured to identify a user of a client computer system regardless of region, identify predetermined remote computing services associated with the user and provide the same.

### BACKGROUND

The current decade has witnessed several promising changes within developing countries with a growing global awareness of their economic potential. A key trend aiding this is the rise of the micro-finance economic model of loans that has helped entire communities out of poverty and bootstrap them into self-sufficient regional economies. Such a model typically involves a financial institution or even private individuals lending small sums of money to the working poor within developing nations to help start or improve a small business within their community.

Several technological trends are also aiding in the spread and accessibility of information technology (IT) resources in developing countries. Some of these trends include the development of remote computing that provides a paradigm shift in computing at low cost, improvements in connection bandwidth that has made remote computing practical, and the proliferation of wireless technologies such as WiFi and cellular technology that have made penetration of Internet access possible to rural and remote locations. Furthermore, there is better local language support, and specialized keyboard/input devices that are also aiding widespread ease of use of computing resources in rural communities.

All of these technologies are coming together in the form of Internet kiosks that provide computing resources shared by a community of people who are charged on a pay per use basis. Within India, for example, the traditional kiosk provider's business model is to set up one kiosk owner within the community to be the kiosk manager. Then, residents who desire to use the kiosk use pre-paid cards. For this business model to work, a community of at least 5000 people is required due to equipment, maintenance and support costs.

In order to meet rural or semi-rural demands, some kiosk providers are starting to make inroads into smaller communities. Examples of three institutions that are bringing such kiosks to rural communities in India are Drishtee, n-Logue, and FirstMileSolutions. These three institutions are similar in that they set up a kiosk within a community and establish a business owner or owners to manage the kiosk. But, they differ on kiosk price point, connectivity solutions, and services (technological and financial). Thus, the various kiosk solutions become very heterogeneous with essentially no one kiosk providing the same user experience.

For example, FirstMileSolutions has a method of meeting the computing and Internet connectivity demand of rural India. They provide a software package that includes a non-real-time Web search engine. This enables users to enter search queries one day and then browse through the results the next day. Thus, it creates a local repository of relevant content with the added benefit that a search for the same keyword by a different user would then become immediately accessible. This cached Web platform can be customized to enable offline clients to experience Web-based content and applications. Additionally, when in areas that have no network coverage, they send a mobile WiFi antenna around a predetermined path between villages and a dedicated Internet connection in a more urban area to provide an intermittent connection between the village and the Internet to exchange data ‘payloads’ between the two.

Drishtee offers a computer, an information center from where the rural entrepreneur or kiosk owner operates, and provides various services to the village community. The rural entrepreneur or the computer owner is provided with a computer, printer, and/or a camera from Drishtree. Using this equipment, he can serve the people of his community and earn his livelihood. The Drishtee model currently also includes Internet connectivity. The services that are offered from the computer are computer training courses, insurance services, agricultural queries, e-governance, business process outsourcing, and rural ecommerce.

Similar to Drishtee, n-Logue also is providing computer access for rural communities. The n-Logue system includes kiosks, and each kiosk costs about $1200 to set up, and includes the following equipment: (i) Wall Set that receives a wireless corDECT signal; (ii) a personal computer (PC) with monitor; (iii) computer peripherals including speaker, microphone, CD-ROM, digital camera, inkjet printer and sound card; (iv) uninterruptable power supply (UPS) with battery providing 4 hours of back-up power for the PC; (v) all required cabling; (vi) an application suite consisting of word-processing, browsing and email software all in a local language as well as in English. The price also includes 6-months of unlimited Internet access, a marketing kit, and introductory training provided by n-Logue.

The n-Logue overall architecture and delivery mechanism is based on a three-tiered model. At the top level is n-Logue, which provides equipment, training and support to local service partners and kiosks, and also takes care of regulatory and connectivity issues. At the second level, n-Logue identifies and partners with a local entrepreneur (also called a Local Service Provider or LSP) in every area it wishes to operate. These LSPs find subscribers, provide services and collect payments. At the bottom level are the village kiosks, which provide services and information aimed at the rural market. With the help of n-Logue, the LSPs recruit the local entrepreneurs who set up the kiosks. Thus, there are up to three business entities involved in the operation, i.e., n-Logue, the LSP and a kiosk operator. All three must thrive for the operation to succeed. The LSPs host access centers that provide last mile access. They also assist in obtaining connectivity to Internet and telecom backbones required for providing Internet and telephone services. For providing last mile access, n-Logue currently uses CorDECT advanced wireless access system. This technology provides 35/70 kbps Internet access. The LSP hosts a wireless tower to transmit the corDECT signal.

As can be seen by these three solutions, one rural area's idea of computing could be quite different from another as you move from location to location even within the same region. Furthermore, to accelerate and to make possible the adoption of such Internet kiosks in villages requires both continued technological advancements as well novel means to finance such kiosks to villagers. While progress has been made on both fronts by companies such as FirstMileSolutions, Drishtee and n-Logue, there are still gaps both economically and technologically to be filled to make it a reality.

Some of the economic and technological difficulties facing these systems are as follows. The cost of kiosks is too high. Kiosk costs may exceed $1200 for kiosk implementation (HW, SW, networking, etc.). A low-cost PC may be used but it will likely under-perform and may limit new operating system (OS) and/or new application support. A PC-based kiosk increases management cost. Software deployment may require on-site installation of packages, which may require extra administrators or kiosk owners with installation knowledge. The connectivity solution to rural or semi-rural areas is generally low bandwidth, such as 35/70 kbps. Lastly, a kiosk owner typically requires a minimum 12th standard education.

Also, there is non-uniformity of user experience from location to location. If a user travels from one village to another, the user must carry his or her data. Also, the kiosk may be different. For example, different villages may use different PCs, different operating systems (OS's), different suite of applications, etc. The user may be unfamiliar with a new PC and unable to operate it.

In addition, the solutions described above do not scale well. For example, if a new OS or new applications are needed, they have to be installed at the client kiosk. Also, hardware may need to be updated to accommodate computing requirements for new applications or OS's. Administrators may need to be paid to do installs or updates, which increases costs.

### BRIEF DESCRIPTION OF DRAWINGS

The embodiments of the invention will be described in detail in the following description with reference to the following figures.

FIG. 1 illustrates a system, according to an embodiment;

FIG. 2 illustrates a method for dynamic resource allocation, according to an embodiment;

FIG. 3 illustrates a method for microfinancing computer resources, according to an embodiment;

FIG. 4 illustrates a method for determining costs related to a client kiosk used to provide remote computing services for a user, according to an embodiment;

FIG. 5 illustrates software modules for determining costs related to a client kiosk used to provide remote computing services for a user, according to an embodiment; and

FIG. 6 illustrates a computer system, according to an embodiment.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In some instances, well known methods and structures have not been described in detail so as not to unnecessarily obscure the embodiments.

### Overview

According to embodiments, a new computing architecture for providing remote computing resources and methods and software for microfinancing and charging for remote computing services are described.

According to an embodiment, a computing architecture for providing remote computing services includes client kiosks, server kiosks and remote management centers. The client kiosks are established in regions, such as local or rural communities, and may use low cost thin clients as the computing infrastructure. Server kiosks provide the computer resources and services for the thin clients at the client kiosks. A kiosk includes a computer system. A kiosk may include a station that provides remote computing services for users. The kiosk may include a housing, I/O devices, etc. The housing can withstand the environment and protect internal computer systems. A kiosk may include furniture or some other structure providing ease of use for users of the kiosk. Kiosks are located in regions. Regions may be large, such as the size of a city or village, or smaller, such as the size of a building. Remote computing services may include computing services provided over network topologies of any size, even within a single building or over large, geographically disbursed regions.

For example, most of the processing, such as running of applications, data storage, etc., is provided on the server kiosks including the computing resources needed for providing these services to the thin clients. A single server kiosk may support multiple client kiosks located in proximity to the server kiosk, such as all the client kiosks in a particular region that have connectivity to the server kiosk.

The server kiosks are remotely managed by remote management centers. For example, a remote management center may manage many server kiosks and includes remote management tools for monitoring and managing the servers.

There are many advantages to the computing architecture described above. The cost for the user is much cheaper because of the use of thin clients. Thin clients are cheaper than providing a full-blown, PC-based work station at every client kiosk. For example, a thin client may have no hard drive or a small hard drive, reducing costs.

Also, the computing architecture scales well and provides for fail-over and load balancing among server kiosks. Sever kiosks may be deployed as “sprinkled data centers” to provide computing services for many different regions. A server kiosk may include multiple servers or blades and each server may support, for example, 50 or more users. Also, due to network infrastructure limitations, only limited bandwidth connections (e.g., low bandwidth, no latency guarantees, etc.) with limited ranges may be available at each client kiosk. Thus, the computing architecture may provide a server kiosk to support many client kiosks in a particular region that are connectable to the server kiosk via the available network. Thus, several server kiosks are provided, each supporting a particular region.

A server in a server kiosk may become overloaded due to excessive computing demands from one or more client kiosks. The server kiosk, however, may include multiple servers or blades. Thus, load balancing and fail over is available between the servers in a kiosk. More servers may be added to a server kiosk as needed, assuming requirements, such as space, cooling and power, are met.

Furthermore, the server kiosks may be connected among each other by higher bandwidth connections. Thus, load balancing and fail over may be provided between server kiosks. Thus, the server kiosks include mechanisms to handle increased number of client kiosks and increased computing demands.

In addition, this architecture scales well to provide new computing services as needed. The thin clients at the client kiosks may not need to be upgraded to provide new applications and OS's. For example, virtualization technology today includes the ability to provide remote user desktops on the thin clients. Thus, the server kiosks are operable to provide a customized user desktop, including OS and software applications, for each user of the client kiosks. Hence, if the user needs to access to a new software application or new OS, the user need not install it on the client kiosk. Instead, it is provided via the remote desktop on the client kiosk. PC-based client kiosks, on the other hand, must be updated manually and may need hardware as well as software updates to accommodate new applications.

Also, as mentioned above, the server kiosks can be connected via a network, and thus are operable to communicate with each other. This provides the ability for a user to have the same user experience on different client kiosks. For example, a user has a desktop associated therewith. The desktop has the particular software applications and data storage needed by the user. When the user logs into any client kiosk, they are presented with the same desktop and data storage, thus providing a uniform client experience among different client kiosks.

It should be noted that this computing architecture reduces costs for the user. For example, the thin client is likely cheaper than a PC-based workstation at the client kiosk. Furthermore, the back-end service provided by the server kiosks is shared among many users and multiple kiosks. Thus, capital costs are reduced, and the savings can be passed on to the users as a reduced cost for a client kiosk and/or a reduced charge for remote computing resources provided via the server and client kiosks.

Also, this computing architecture can use heterogeneous computer resources and still provide the remote computing services for the user. For example, the servers in a server kiosk may be different or servers in different server kiosks may be different. Also, the thin clients at the client kiosks may be different, and connections between client kiosks and server kiosks as well as connections between sever kiosks may be different. However, this computing architecture is still operable to provide the remote computing services for the user.

According to embodiments, methods are provided for microfinancing remote computing services and for determining charging rates for users. Microfinancing can be provided to purchase a client kiosk. For example, one individual or multiple individuals in a village can microfinance the purchase of a client kiosk.

Also, microfinancing may be provided for the purchase of usage of remote computing services provided via the client kiosk. For example, depending on the applications needed by the user, whether the user needs remote data storage, the amount of usage per month or per some other time period, credit history and other customer profile factors, an amount to charge for usage is determined. This amount may be microfinanced.

Additionally, a pay-as-you-go plan can be implemented for those who don't require micro-financing. For example, users may be charged for the time the client kiosk was used and/or the services used on the client kiosk. There may be one rate for only Internet access and another rate that includes access to applications and remote storage. Also, services, such as email and web hosting, may be provided for small business customers or other customers that have a need. Note that even with microfinancing, users may be charged for the remote services used on the pay-per-use basis. Initially, the microloan may be based on initial cost and the estimated usage of the remote computing service. Once the actual usage occurs, the actual usage of the remote compute service is monitored and accordingly the user may be charged and the loan may be adjusted.

Thus, flexible micro-financing is available. Also, superior cost of ownership is achieved. For example, system maintenance and support is shifted to back end services. Also, computing resources and remote computing services can be financed via usage (e.g., ˜20 cents/hour) and micro-loans can be used to recoup the cost of back end equipment in a time span usually significantly less (i.e., 1 to 2 years) than typical warrantee expiration (i.e., 3 to 5 years) of the equipment.

### System Architecture/Computing Architecture

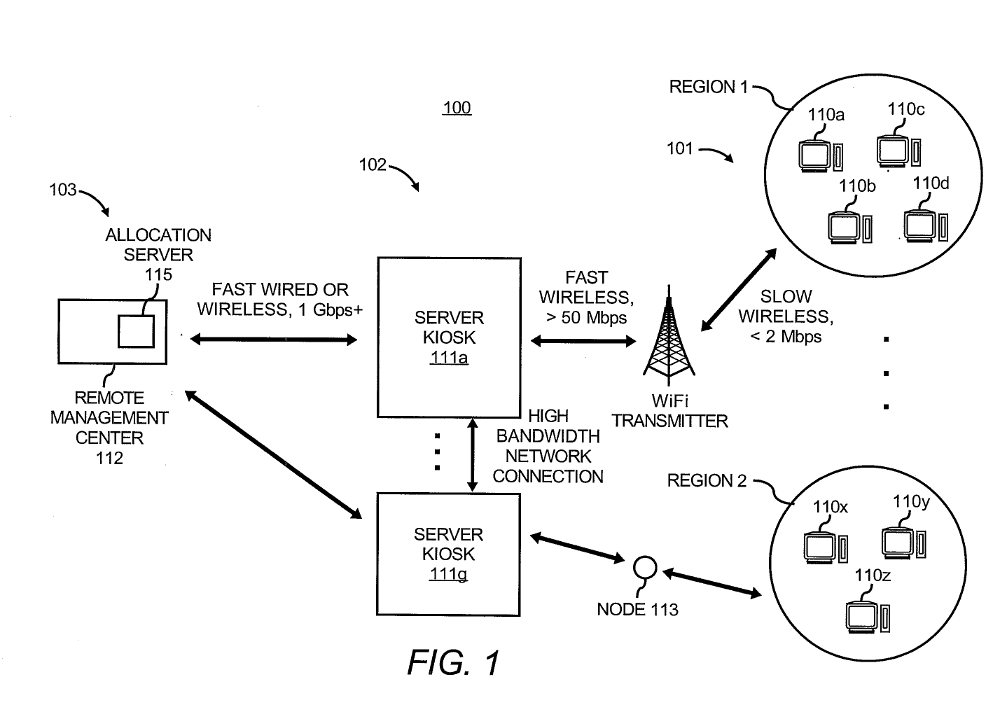

FIG. 1 illustrates a system 100 that includes the computing architecture according to an embodiment. The computing architecture employs an architecture that can be used for meeting the computing demands for emerging markets or computing demands for other markets. As shown in the system 100, the computing architecture includes multiple layers 101-103. Layer 101 includes client kiosks 110, shown as 110a-z; layer 102 includes server kiosks 111a-g; and layer 103 includes a remote management center 112. It will be apparent to one of ordinary skill in the art that each layer may include many more systems than shown. For example, multiple server kiosks may serve multiple client kiosks. Also, multiple remote management centers may be used to service many areas.

The client kiosks 110 can be established at local rural communities and use low cost thin clients as the computing infrastructure. The thin clients may have only the most basic computing power support with an optional support for remote graphics compression. For example, the thin client may run only a web browser and remote desktop software that provides for running applications on a server kiosk. The thin client may not include a hard drive. As opposed to a PC-based kiosk, the thin-client-based kiosk does most data processing on the server side. However, a PC-based kiosk may alternatively be used for the client kiosk, depending on the client requirements.

The client kiosks 110 may be designed for a low cost region. Furniture and outer shells may be designed and provided for the environment that the client kiosks will be used in. Special character keyboard requirements may be implemented as well as any specialized software. Also, guides and training may be provided for the owner/operator of the client kiosk. Also a network interface is provided to accommodate the type of connection to the server kiosk, such as WiFi, GSMA (3G cell technology) or wired.

Below are some examples of client kiosks. A general purpose client kiosk may be PC-based and include a convention OS, a browser, applications, such as word processing, spreadsheet, and email/contact management. This type of kiosk is easy to manage and user data can be saved on to USB drives or other portable storage. However, hardware and software updates may need to be performed by an administrator locally, increasing costs.

Another type of client kiosk that may reduce capital and operating costs includes a thin-client and uses virtualization technologies to provide access to applications (e.g., PC applications such as word processing, spreadsheet, educational software, Internet browser, etc.), the Internet, remote data storage, etc. This client kiosk needs good quality of service and bandwidth connections to the server kiosk. Remote desktops hosted by a server in a server kiosk may be provided to the client kiosks, and can be customized for each user.

Another type of client kiosk provides a full OS and hard drive space for user data. User space could be provided locally in each user's profile. Client kiosks may include accessories such as a display, keyboard and other I/O devices, web cam, CD/DVD, printer, etc. Low power computers and peripherals may be used.

The client kiosks 110a-z may be connected to the server kiosks 111a-g using a wireless infrastructure. The wireless infrastructure may include a long range Wi-Fi connection. The WiFi connection may include a lower bandwidth connection between the client kiosks 110, e.g., less than 2 Mbps, and a WiFi transmitter, and a greater bandwidth connection, e.g., greater than 50 Mbps. This is illustrated by the client kiosks 110a-d in region 1 connected to the server kiosk 111a via a network node shown as a WiFi transmitter. A wired connection may alternatively be used if available, and instead of a WiFi connection, client kiosks may be connected to a server kiosks using another type of network node. This is illustrated with respect to the client kiosks 110x-z in region 2 connected to the server kiosk 111g via network node 113. The node 113 may provide a wired network connection if available.

The network connection between the client kiosks 110 and server kiosks 111 may be provided by an LSP. The LSP is a network provider that typically provides a wired leased line connection to an Internet Service Provider (ISP). The server kiosks 111 may be provided and maintained by the LSP.

The server kiosks 111a-g include one or more of servers, blade workstations, and blade PCs to cater to the computing needs of the client kiosks 110. Multiple client kiosks may connect to the same server kiosk. Unlike large data centers housing thousands of computers, a server kiosk may be small. In one example, the server kiosk may include one or a few racks where servers or blades are mounted, and a small housing to protect the one or few racks. The housing is designed to withstand the environmental conditions of its location. This may include a hardened steel housing. Also, accessory systems, such as power and cooling systems are provided and provisioned for the environment. For example, solar power may be used to supply power at least some of the time for the server kiosk.

The server kiosks 111a-g can be remotely managed by the remote management center 112. For example, the remote management center 112 uses automated management tools, such as provisioning and diagnostics, and remotely accesses the servers in the server kiosks 111a-g using management processors. The communication channels between the server kiosks 111a-g and the remote management center 112 can be based on wired infrastructure with sufficient bandwidth. Several remote management centers may be provided to cater to several server kiosks.

Each server kiosk 111a-g shares its computing resources. e.g., servers, blades, etc., among multiple users, for example, based on time-of-day workload patterns and virtualization technologies. For example, each server or a blade may provide virtual desktops for many users, which may vary based on work load of the server or blade. A heterogeneous infrastructure is provided in terms of both different types of OS's as well as different classes of blade PCs.

The server kiosks 111a-g also optionally provides web hosting and storage services as well as provides support for custom software, such as educational training software provided personalized based on the user profile. Several client kiosks may be in the vicinity of a server kiosk and similarly several server kiosks may be in the vicinity of a client kiosk. The allocation of a server kiosk to client kiosk may be made dynamically based on bandwidth and service level agreements. Also, if a server kiosk is heavily loaded, it can serve as a proxy and re-direct the request to a peer server kiosk. In this way, decentralized resource allocation and load balancing functions may be used.

Regions 1 and 2 are shown to illustrate that a server kiosk may be provide remote computing services, such as virtual desktops, etc., to client kiosks within a region based on the server kiosks proximity to the region. Due to possible limitations of the network infrastructure, a client kiosk may only be able to connect to a server kiosk if the server kiosk is within a predetermined proximity to the client kiosk. For example, server kiosk 111a provides remote computing services to client kiosks 110a-d in region 1, and server kiosk 111g provides remote computing services to client kiosks 110x-z in region 2, which is geographically distributed from region 1. In this example, server kiosk 111a is located close to region 1 and server kiosk 111g is located close to region 2.

Also, the server kiosks 111a-g are connected to each other via network connections, which may be higher bandwidth and faster network connections than the WiFi connections used by the client kiosks. The server kiosks 111a-g are connected to each other to provide load balancing amongst each other and also to provide the same remote computing services for a user regardless of the region the user is in. For example, a user logs into a client kiosk 110z. The login information is sent to an allocation server 115 in the remote management center 112 via the server kiosk 111g. The allocation server 115 may store user account information for each user, including user profiles and remote computing services that the user has been approved to receive. In one example, the remote computing services includes a virtual desktop with the software applications that the user previously requested. The allocation server 115 identifies the particular remote desktop for the user to the server kiosk 111g, and the server kiosk 111g provides that remote desktop to the user via the client kiosk 110z. If the user was in region 2, the user could log into a client kiosk in region 2 and receive the same remote desktop.

Remote data storage may also be a computing service provided to the user. For example, the user's data may be stored in the server kiosk 111g. The user's data is transferred to the server kiosk 111a if the user is using a client kiosk in region 1 instead of region 2. Thus, in this architecture, data is stored in a server kiosk and passed to other server kiosks as needed.

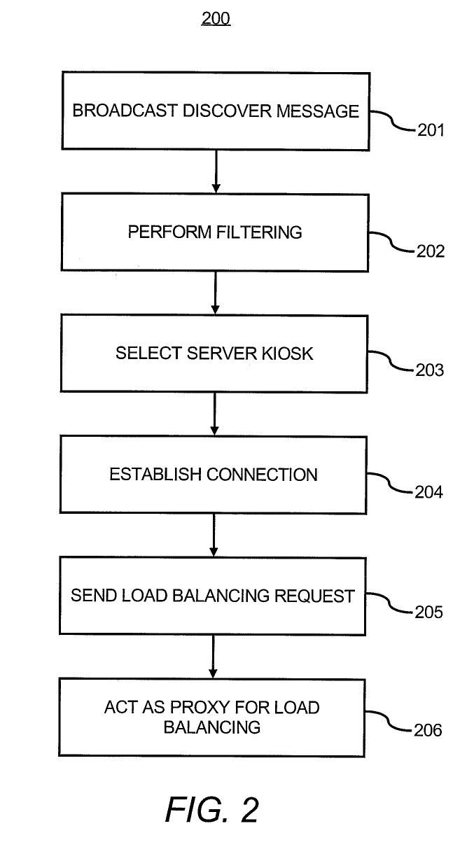

FIG. 2 illustrates a method 200 for dynamic resource allocation, according to an embodiment. The method 200 may include one or more steps executed at a client kiosk or a server kiosk.

At step 201, a “Discover” message is broadcasted from a client kiosk to find all server kiosks in the vicinity.

At step 202, a 2-phase filtering is performed on server kiosks that respond to the “Discover” message. In phase 1, the set of server kiosks that satisfy bandwidth and latency requirements are determined. A probe message is sent to all of the responding server kiosks to measure bandwidth and latency for this purpose. In phase 2, the client kiosk sends a message to all of the server kiosks identified in phase 1 that satisfy bandwidth and latency requirements. The phase 2 message sent to the server kiosks specify the client-side requirements, such as the set of applications desired and the computing/storage requirements.

At step 203, the client kiosk iterates over the results returned by all of the filtered server kiosks and then selects one of the server kiosk either through a best fit, first fit, or random selection.

At step 204, once a server kiosk is selected, the client kiosk establishes a persistent connection with it.

At step 205, if over time, the server kiosk gets heavily loaded, the server kiosk initiates a load balancing request and asks other server kiosks in the vicinity of the client kiosk if it can start serving the load of the client temporarily.

At step 206, if a server kiosk responds, the initially selected server kiosk starts serving as a proxy and re-directs the requests to the peer server kiosk that responded in this step. The proxy operation may be performed transparent to the client kiosk, or the allocated server side kiosk can indicate to the client kiosk to do a re-allocation.

The computing architecture shown in FIG. 1 provides interesting challenges for the administration and day-to-day operations of the kiosks. Unlike contemporary enterprise information technology (IT) infrastructures that are being consolidated into few large data centers, system 100 includes “sprinkled data centers” where a large number of relatively small sized data centers, i.e., the server kiosks, are spread over a wide geographical area. Managing these at a low cost can be achieved through automation technologies.

The remote management centers are responsible for remotely operating the server kiosks, for example, using automation technologies. The remote management centers are geographically distributed such that each remote management center is responsible for a set of server kiosks in a circular radius of its geographical area. The allocation of a remote management center to a server kiosk may be initiated by the server kiosk. The management of client kiosks may be handled by LSPs and is independent of remote management centers. Each remote management center provides a web services interface for programmatic management of the server kiosks.

The functionality provided by remote management centers is related to the lifecycle management of the server kiosks, such as provisioning, operations, changes, and shutdown. The provisioning functionality is provided through the use of automation technologies that create a workflow of activities to be performed and then remotely transfer the images to the server kiosks. Also, the remote management centers continuously or periodically monitor servers and applications on the server kiosks. For example, collected logs are transferred to the remote management centers over the network. At the remote management centers, analytical engines leverage knowledge gained over a historical period of time to apply diagnostic rules to this data. Since each remote management center may serve multiple server kiosks, the knowledge/policies can be leveraged across server kiosks.

Management processors play a key role in remote administration providing the ability for administrators at remote management centers to login to the management processors in a secure, isolated manner, independent of the state of the host machine. Examples of management processors include Hewlett-Packard's (HPs) iLO/GSP, Intel's AMT, and IPMI compliant BMC (iLO stands for Integrated Lights Out, GSP stands for Guardian Service Processor, AMT stands for Active Management Technology, IPMI stands for Intelligent Platform Management Interface and BMC stands for Baseboard Management Controller). A management processor may communicate with processors of a computer system to receive information for monitoring the processors and managing the processors. The management processor may include firmware for performing management functions on the processors, such as powering on or off or rebooting, monitoring temperature, power, and other attributes, and performing other management functions. Metrics related to lifecycle management are captured by the management processors and sent via the management processors to the remote management centers.

The management processors may form a hierarchical topology among themselves for the efficient dissemination of information. Similarly, policy decisions are either propagated through the same topology or closed loop topologies are also formed wherever appropriate to improve the efficiency of decision making.

### Remote Computing Service Usage Charges and Microfinancing

The computing architecture is described above with respect to FIGS. 1 and 2 that can be used to providing computing resources in emerging markets. According to embodiments, improved methods may also be used to provide computing services in emerging markets. The methods consider some aspects including: (i) initial capital cost of client kiosk IT resources; and (ii) the operating cost of using the resources at the server kiosk on a pay-per use basis. These two different costs are tied into a microfinancing and historical usage model. Below, a method is described to determine when and where the microfinancing can be applied.

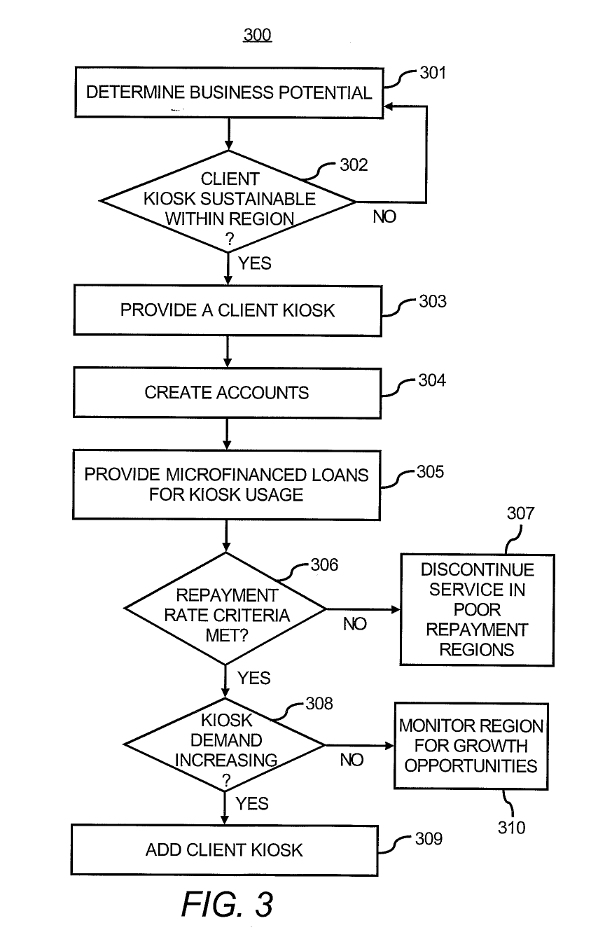

FIG. 3 illustrates a method 300 for microfinancing computer resources, according to an embodiment. The method 300 may be used for emerging markets or other markets.

At step 301, a business potential is determined for a particular region. For example, user demand for a client kiosk in a particular rural area is determined. Demand may be determined and/or generated through regional marketing and/or potential user contact through microfinance organizations.

At step 302, a determination is made as to whether a client kiosk is sustainable with the region. In one example, user demand within a community (village, town, etc.) must meet criteria for a sustainable, microfinanced, Internet, client kiosk. These criteria could include number of users, availability of cost effective Internet access providers (e.g., LSPs), cost effective partnerships with existing kiosk service providers, government subsidy, whether someone in the region is willing and capable to be a client kiosk owner and administrator, etc.

If a client kiosk is determined not to be sustainable at the current time, the demand in that region and other regions is continued to be monitored, because the criteria for the client kiosk may be met at a later time.

If a client kiosk is determined to be sustainable at step 302, a business, such as HP, contacts a regional service provider, such as an LSP, and/or provides the client kiosk for installation in the region at step 303. The business may provide the client kiosk directly to the region. Providing the client kiosk for the region may include selling or leasing the client kiosk to an individual, multiple users, or an entire community of users. Microfinancing may be provided for the purchase or lease of the client kiosk.

At step 304, individual users in the region are identified and accounts are created for the users. For example, the business works with the users to determine the types of accounts and account options needed. This may include identifying the type of Internet access and storage needed and the type of software applications needed. These software applications may include conventional PC software, such as word processing, spreadsheets, etc., or customized software, such as educational software. This may include an up-sell from basic offerings depending on each individual user's needs.

At step 305, the business or another entity provides each user, if needed, microfinanced client kiosk usage time either directly or through a microfinance partnership. Microfinancing includes loans below a maximum amount, such as below one or two thousand dollars. Microfinancing is usually provided to poor people, such as people in villages, and financing from typical financial institutions is not available or the people will not qualify for loans. The business providing the micro-financing may have goals that include both profitability and humanitarian (i.e., reducing the poverty level of their clients).

At step 305, criteria are evaluated when determining whether to grant a loan and to determine the loan amount. For example, for every possible user, a credit history is maintained. Basically, it reflects the financial status of the user and its history in terms of loan payments. Furthermore, a usage pattern history of the user in terms of its workload usage is recorded. This helps to determine the estimated operating cost for the user. Based on such credit history information and usage pattern history, an appropriate loan amount for the user such that it covers both the capital costs and operating costs is calculated. Any other information, impacting the user's ability to pay the loan may also be considered. For example, the user may have other income that would help the user obtain the loan. If credit history and usage pattern information is not available, a base loan amount may be given. Different users obtain different loan amounts thus providing for differentiated services.

The user pays for usage of the client kiosk based upon their client account agreement and using their microfinancing. The payments are used by the business providing the client kiosk to pay for the computing resources.

Once the loan amount is determined in step 305, existing mechanisms for executing the microfinancing as well as determining the operating charge for the user based on utility computing concepts can be used. In case the users' workload usage pattern differs from what was estimated during the initial loan assignment, the loan amount is accordingly adjusted. Such a feedback based re-adjustment of microfinanced loans based on IT usage patterns is unique.

At step 306, a determination is made as to whether a re-payment rate for the region is met. Re-payment rate is the number of users that provide payment on their loans versus the number of users that default, over a predetermined time period. The re-payment rate is not met, for example, if the ration of defaulting to paying users exceeds a predetermined amount. Those users who default on the microfinanced loan will have service discontinued at step 307. For example, their accounts are suspended until payment is made. Also, if demand falls below a predetermined amount, the services provided through the client kiosk may be discontinued. The client kiosk may be moved to another location. Service may be re-continued if demand later increases.

At step 308, regions that have a healthy demand and re-payment rate are periodically considered for an increase in client kiosks to meet increasing demand. For example, criteria is set, e.g., predetermined demand and/or re-payment rate. If the criteria is met, then another client kiosk may be added at step 309. Otherwise, the region is continually or periodically monitored for growth opportunities, such as the need for new client kiosks, at step 310.

The idea of using microfinancing to provide access to IT resources has implications in a wide market segment each with a different revenue and cost model. While one market segment is those targeted by traditional micro-finance institutions namely the rural and poor communities, the IT microfinancing according to the embodiments can expand the scope to also finance small to medium businesses in towns and cities that are not large enough to afford business IT solutions needed to automate their backend services such as payroll, supply chain etc. Furthermore, IT micro-financing in its initial stages may be more suited to be targeted at “literate” communities that can take good advantage of provided IT resources, as well as communities that are already beyond a minimum threshold poverty line.

IT microfinancing differs in scope and nature from other typical, traditional microfinance and microcredit based financial services. This is fundamentally due to the fact that the financed resources tied to the micro loan is in fact a technology solution that itself is associated with a charging model. In short, the actual resource financed via microfinancing becomes merely the utilization of the one of more services provided by the technology solution and not traditional physical assets such as equipment and raw materials. Furthermore, since the use of the computing resource is for long term and is potentially renewable to other forms of IT resources, a credibility parameter (e.g., credit history, usage history, etc.) of the end-user can be factored in while determining the loan amount and interest rate to the borrower.

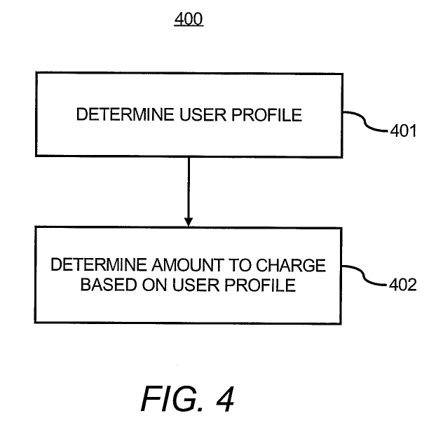

FIG. 4 illustrates a method 400 for determining costs related to a client kiosk used to provide remote computing services for a user.

At step 401, a user profile is determined for a user. The user profile may include a credit history and an estimated amount of usage of the remote computing services for the particular user.

Initially, when a first time user desires to use the remote computing services, the user may not have a credit history and a history of previous usage of the remote computing services. In these instances, an estimation of future usage is determined based on the user's needs. For example, a user profile may include the interests and remote computing service needs of the user. For example, one user may need remote computing services for on-line training or education. Another user may need remote computing services primarily for Internet access, and yet another may need remote computing services may primarily word processing. Based on previous users' profiles, which may contain amount of usage of computing services, credit history, type of computing services provided, amount charged for different usage amounts and types of computing services, etc., a remote computing services type model is created and stored. The remote computing services type model may be used to estimate charges for a new user based on the type of remote computing services the user is requesting.

At step 402, an amount to charge the user for use of the remote computing services is estimated. The charge amount may be for a predetermined amount of time, such as per week or per month or per hour, and is based on the user profile.

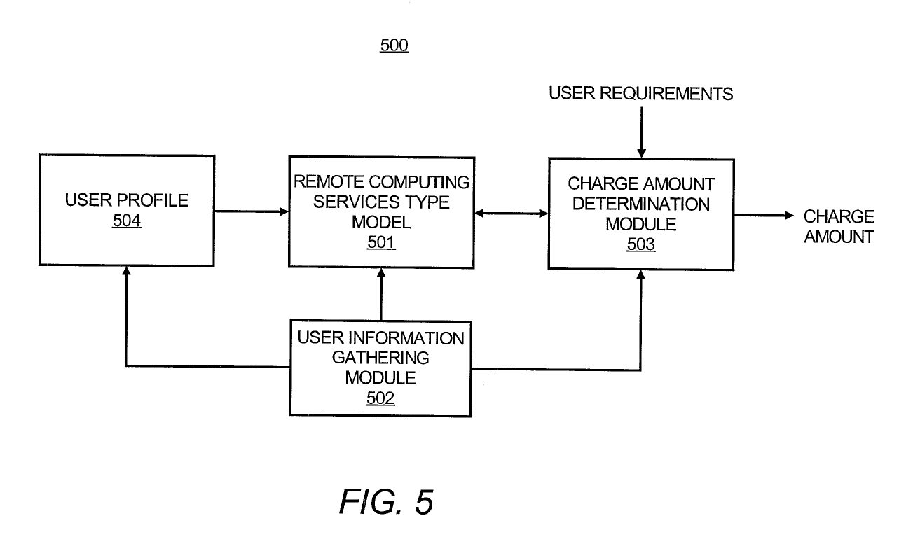

FIG. 5 illustrates software modules, representing computer code providing the functionality for each model, and data that can be used by the method 400 to determine the amount to charge a user for remote computing services.

A user information gathering module 502 determines information for user profiles 504 and a remote computing services type model 501. The user information gathering module 502 gathers user profile information, such as user identification and login information, type of computing services requested by a user, credit history, amount of usage of any existing computing services for the user, amount charged for any existing computing services, demographics, etc. The user information gathering module 502 may gather this information from information provided from the user, sensors for monitoring existing computing services, third party organizations that gather this information, etc. The gathered information is stored as the user profiles 504.

The remote computing services type model 501 also includes at least some of this information. For example, the model includes different types of computing services provided, the estimated amount of usage of the computing services for each type, credit history, and the amount charged for each type.

A charge amount determination module 503 receives user requirements for a user. The user requirements are the computing services needs of the user. For example, the user may request primary use for on-line training. The charge amount determination module 503 matches the user requirements to a closest type of computing services in the remote computing services type model 501 and uses an estimation of charge amount from the model for that type as the charge amount applied to the user.

If the user requirements change or if other criteria change, the amount charged is updated. For example, the user may need more services, or the user needs more usage time than previously estimated or the user's credit history has changed, then the amount charged is changed.

FIG. 5 is one example of estimating amount to charge a user for computing services. Different models and modules may be applied to determine charge amount for computing services.

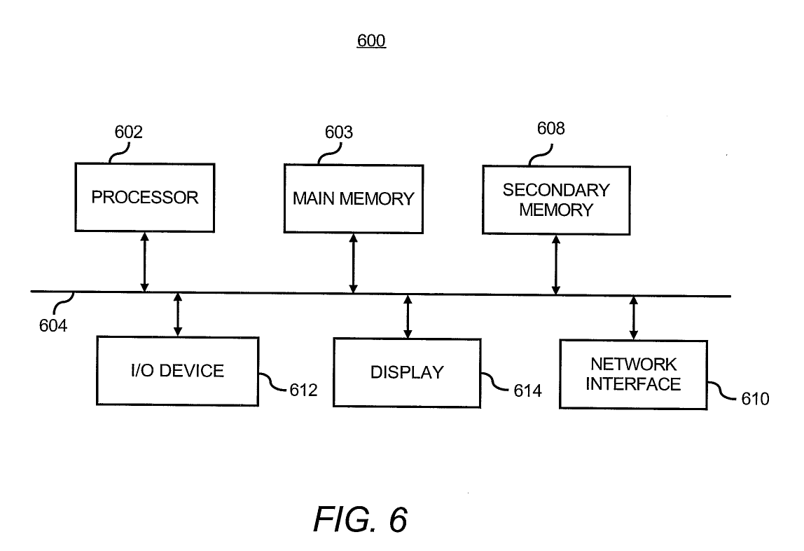

FIG. 6 illustrates a block diagram of a general purpose computer system 600 that is operable to be used to execute one or more computer programs implementing the embodiments described herein, including steps described herein. Also, the computer system 600 generally represents the platform for a client kiosk or a server kiosk. It will be apparent to one of ordinary skill in the art that a more sophisticated computer system is operable to be used. Furthermore, components can be added or removed from the computer system 600 to provide the desired functionality.

The computer system 600 includes one or more processors, such as processor 602, providing an execution platform for executing software. Commands and data from the processor 602 are communicated over a communication bus 604. The computer system 600 also includes a main memory 606, such as a Random Access Memory (RAM), where software is resident during runtime, and a secondary memory 608. The secondary memory 608 includes, for example, a hard disk drive and/or a removable storage drive representing a floppy diskette drive, a magnetic tape drive, a compact disk drive, etc., or a nonvolatile memory where a copy of the software is stored. In one example, the secondary memory 608 also includes ROM (read only memory), EPROM (erasable, programmable ROM), EEPROM (electrically erasable, programmable ROM). The computer system 600 includes a display 614 and user interfaces comprising one or more input/output (I/O) devices 612, such as a keyboard, a mouse, a stylus, and the like. However, the I/O devices 612 and the display 614 are optional and other shown components. A network interface 610, wired and/or wireless, is provided for communicating with other computer systems.

One or more of the steps of the methods described herein and other steps described herein may be implemented as software embedded on a computer readable medium, such as the memory and/or data storage, and executed on a computer system, for example, by a processor. The steps may be embodied by one or more computer programs, which may exist in a variety of forms both active and inactive. For example, they may exist as software program(s) comprised of program instructions in source code, object code, executable code or other formats for performing some of the steps. Any of the above may be embodied on a computer readable medium, which include storage devices. Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes.

While the embodiments have been described with reference to examples, those skilled in the art will be able to make various modifications to the described embodiments without departing from the scope of the claimed embodiments.

1. A system providing remote computing services comprising:
client computer systems located in a plurality of geographically distributed regions, each region including a subset of the client computer systems, wherein the client computer systems are used to receive remote computing services;
server computer systems, each server computer system servicing a particular one of the regions by providing the remote computing services for the subset of the client computer systems in the region;
first network connections providing connectivity between each client computer system and the corresponding server computer system; and
second network connections connecting the server computer systems amongst each other,
wherein each of the server computer systems are configured to identify a user of a client computer system regardless of the region the client computer system is located in, identify predetermined remote computing services associated with the user, and provide the predetermined remote computing services to the client computer system being used by the user.

2. The system of claim I, wherein the remote computing services comprise virtual remote desktops providing personal computer software applications for the user, and each server computer system is configured to include a plurality of servers, and each server is configured to provide a plurality of the remote desktops for a plurality of users.

3. The system of claim 1, wherein if a server computer system becomes over loaded, the server computer system operates as a proxy and forwards requests from client computer systems serviced by the server computer system to a peer server computer system that has capacity to service the requests.

4. The system of claim 1, further comprising:
a remote management center including management tools for continuously or periodically monitoring the server computer systems and performing lifecycle management on the server computer systems based on the monitoring of the server computer systems.

5. The system of claim 4, wherein the remote management center includes an allocation server configured to identify a user using a client computer system and instruct a server computer system to provide the client computer system with predetermined remote computing services associated with the user.

6. A system providing remote computing services, comprising:
client computer systems located in a plurality of geographically distributed regions, each region including a subset of the client computer systems, wherein the client computer systems are used to receive remote computing services;
server computer systems including a plurality of servers, wherein each of the servers is configured to provide remote computing services for client computer systems in one of the regions and the remote computing services are customizable for each user and the same remote computing services for a particular user are available to the user on any of the client computer systems in any of the regions;
a first network interface providing a low bandwidth connection connecting the servers in at least one server computer system to the client computer systems in the particular region;
a second network interface providing a higher bandwidth connection to other server computer systems and to a remote management center; and
wherein the servers are operable to use the second network connection for load balancing amongst the server computer systems and to provide the same remote computing services for the user in other regions.

7. The system of claim 6, wherein a server in the server computer systems is configured to provide computing services for a first of the client computer systems by executing instructions to:
broadcast a discover message from a client computer system;
identify a set of server computer systems that responded to the discover message and satisfy bandwidth and latency requirements;
send a message to the set of server computer systems, wherein the message includes client-side requirements wherein the client-side requirements include at least one of a set of applications desired and computing or storage requirements; and
select one of the server computer systems that can satisfy the client-side requirements.

8. The system of claim 7, wherein if the selected server computer system gets overloaded, the selected server computer system initiates a load balancing request to other server computer systems in the vicinity of the client computer system, wherein the overloaded server computer system serves as a proxy and re-directs requests from the client computer system to a peer server computer system.

9. A method of providing remote computing resources, the method comprising:
microfinancing purchase of a client computer system for a region, wherein the client computer system includes computer resources and is operable to provide computer services to users of the client computer system;
microfinancing usage of the remote computer services provided via the client computer system for at least one of the users; and
providing a pay-as-you-go usage of the remote computer services provided via the client computer system for at least one of the users.

10. The method of claim 9, wherein microfinancing usage of the remote computer services provided via the client computer system for at least one of the users further comprises:
determining history of usage of the remote computing services for the at least one users;
determining credit history for the at least one user; and
providing microfinancing for the at least one user based on the history of usage and credit history.

11. The method of claim 9, wherein prior to microfinancing the client computer system, the method further comprises:
determining whether re-payment rate criteria are met;
if the re-payment criteria are met, determining whether there is an increase in demand for another client computer system; and
if any of the re-payment criteria are not met, determining whether to discontinue services provided via the client computer system.

12. The method of claim 9, wherein microfinancing usage further comprises:
determining a user profile for the at least one user, wherein the user profile includes a credit history and an estimated amount of usage of the remote computing services which are operable to be provided via the client computer system; and
estimating an amount of a charge to the at least one user for use of the remote computing services for a predetermined amount of time based on the user profile.

13. The method of claim 12 further comprising:
microfinancing the amount of the charge.

14. The method of claim 12 further comprising:
updating the user profile based on changes to the remote computing services needed by the at least one user or the estimated amount of usage; and
determining a new amount to charge based on the changes.

15. The method of claim 12, further comprising:
determining a type of remote computing services needed by the at least one user; and
using a remote computing services type model to estimate the amount of usage of the remote computing services.
